(19) United States
(12) Patent Application Publication
(10) Pub. No.: US 2023/0150308 A1
(43) Pub. Date: May 18, 2023

(54) TIRE STRUCTURE

(71) Applicant: The Goodyear Tire & Rubber Company, Akron, OH (US)

(72) Inventor: Babatunde Omogbolahan Agboola, Uniontown, OH (US)

(21) Appl. No.: 17/525,100

(22) Filed: Nov. 12, 2021

(51) Int. Cl. B60C 7/14

(52) U.S. Cl. CPC B60C 7/146

(57) ABSTRACT

A tire includes a radially inner annular rim with a central axis, an annular shearband disposed radially outward from the inner rim, an annular supporting structure disposed radially outward from the inner rim, the supporting structure radially interconnecting the inner rim and the shearband, and an annular tread disposed radially outward from the shearband. The supporting structure includes a plurality of spokes each having a radially outer teardrop loop and a radially inner triangular structure with a radially inner vertex of the teardrop loop and a radially outer vertex of the triangular structure converging at a single location. A ratio of a maximum radial height of the teardrop loop to a maximum circumferential width of the teardrop loop is in a range between 1.00 and 2.00.

### FIELD OF THE INVENTION

The present invention relates generally to a pneumatic or non-pneumatic tire, and more particularly, the present invention defines a structure for support an appropriate load for a vehicle.

### BACKGROUND OF THE INVENTION

A conventional non-pneumatic tire for a vehicle may include an inner hub, sometimes referred to as a wheel, surrounded circumferentially by an radially outer disposed tread that includes an annular shear band. The inner hub may be made of metal and have a high degree of conductivity. The non-pneumatic tire may include a series of spokes that are disposed radially between the inner hub and the tread. The spokes can be made of polyurethane and cycle between tension and compression upon every revolution of the tire. A shear band may also be included within the non-pneumatic tire and be located radially between the spokes and the tread.

As this type of non-pneumatic tire rotates under load, the spokes experience bending, extension, and compression deformation when they are located downward near the contact patch of the tread. The spokes straighten outside the contact patch relieving the bending and compression deformation. The spokes thus experience cyclic deformation as the tire rotates. These repeated deformation cycles may cause fatigue in the spokes and limit the life of the spokes and the non-pneumatic tire.

### SUMMARY OF THE INVENTION

A tire in accordance with the present invention includes a radially inner annular rim with a central axis, an annular shearband disposed radially outward from the inner rim, an annular supporting structure disposed radially outward from the inner rim, the supporting structure radially interconnecting the inner rim and the shearband, and an annular tread disposed radially outward from the shearband. The supporting structure includes a plurality of spokes each having a radially outer teardrop loop and a radially inner triangular structure with a radially inner vertex of the teardrop loop and a radially outer vertex of the triangular structure converging at a single location. A ratio of a maximum radial height of the teardrop loop to a maximum circumferential width of the teardrop loop is in a range between 1.00 and 2.00.

According to another aspect of the tire, the supporting structure includes between 4 and 80 spokes.

According to still another aspect of the tire, the supporting structure includes between 20 and 60 spokes.

According to yet another aspect of the tire, the supporting structure includes between 30 and 50 spokes.

According to still another aspect of the tire, the supporting structure includes 40 spokes.

According to yet another aspect of the tire, the supporting structure includes 36 spokes.

According to still another aspect of the tire, each spoke is symmetric about a radially extending midplane of each spoke.

According to yet another aspect of the tire, each spoke has a radially outward-facing fish-like structure.

According to still another aspect of the tire, each triangular structure has two angled legs.

According to yet another aspect of the tire, each spoke has a uniform construction.

According to still another aspect of the tire, a first spoke has a first construction and a second spoke has a second, different construction.

According to yet another aspect of the tire, each spoke has a uniform axial width.

According to still another aspect of the tire, the ratio is in a range between 1.00 and 1.50.

According to yet another aspect of the tire, the ratio is in a range between 1.10 and 1.40.

According to still another aspect of the tire, the ratio is in a range between 1.20 and 1.30.

According to yet another aspect of the tire, a maximum circumferential width of each triangular structure is greater than the maximum circumferential width of the teardrop loop.

A method in accordance with the present invention supports part of a vehicle load. The method incudes the steps of: extending a radially inner annular rim circumferentially about a central axis; extending an annular shearband circumferentially about the central axis; radially interconnecting the inner rim and the shearband with an annular supporting structure; extending an annular tread circumferentially radially outward from the shearband; converging a radially inner vertex of a teardrop loop of the supporting structure and a radially outer vertex of a triangular structure of the supporting structure at a single location; and defining a ratio of a maximum radial height of a teardrop loop of the supporting structure to a maximum circumferential width of the teardrop loop in a range between 1.00 and 2.00.

According to another aspect of the method, a further step incudes defining a ratio of a maximum radial height of a teardrop loop of the supporting structure to a maximum circumferential width of the teardrop loop in a range between 1.00 and 1.50.

According to still another aspect of the method, further steps include defining a first construction of a first spoke of the supporting structure and defining a second different construction of a second spoke of the support.

According to yet another aspect of the method, a further step includes defining the supporting structure spokes having radially outward-facing fish-like structures symmetric about a radial midplane.

### BRIEF DESCRIPTION OF THE DRAWINGS

A full and enabling disclosure of the present invention, including the best mode thereof, directed to one of ordinary skill in the art, is set forth more particularly in the remainder of the specification, which references the appended Figures, in which:

FIG. 1 is a schematic side view of an example tire in accordance with the present invention.

FIG. 2 is a schematic side view of an example tire functionally similar the tire of FIG. 1.

FIG. 3 is a schematic perspective view of another example tire functionally similar to the tire of FIG. 1.

FIG. 4 is a schematic side view of the tire of FIG. 3.

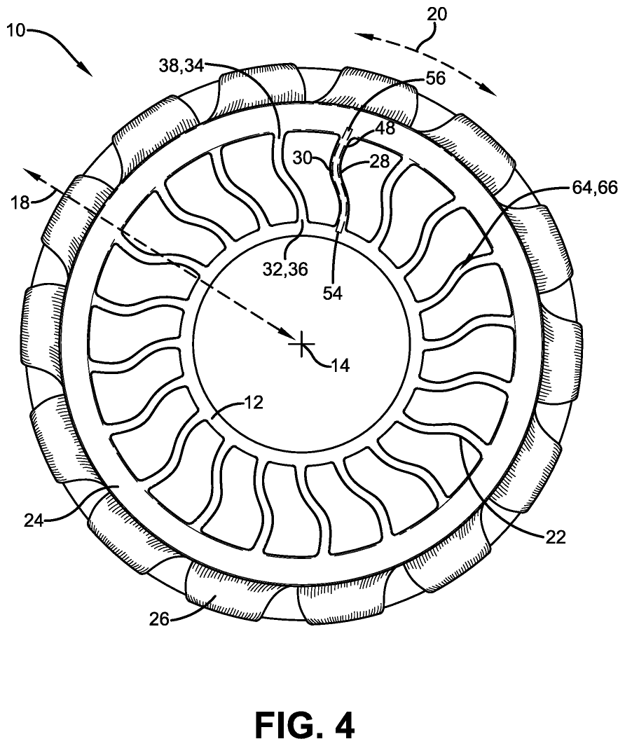

FIG. 5 is a schematic cross-sectional view of another portion of the tire of FIG. 3.

FIG. 6 is a schematic enlarged side view of part of the tire of FIG. 1.

Repeated use of reference characters in the present specification and drawings is intended to represent the same or analogous features or elements of the present invention.

### DETAILED DESCRIPTION OF EXAMPLES OF THE PRESENT INVENTION

Reference will now be made in detail to examples of the present invention, one or more examples of which are illustrated in the above-described drawings. Each example is provided by way of explanation of the present invention, and not meant as a limitation of the present invention. For example, features illustrated and/or described as part of one example may be used with another example to yield still a third example. It is intended that the present invention include these and other modifications and variations.

U.S. Pat. No. 9,027,615, hereby incorporated herein in its entirety, describes a representative example pneumatic tire for use with the present invention. U.S. Pat. No. 10,926,581, hereby incorporated herein in its entirety, describes a representative example non-pneumatic tire for use with the present invention. U.S. Patent Publication No. 2017/0368879, hereby incorporated herein in its entirety, describes another representative example non-pneumatic tire for use with the present invention.

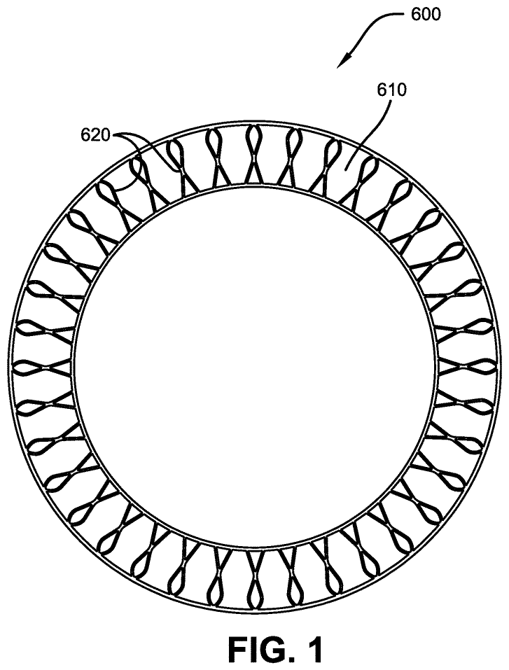

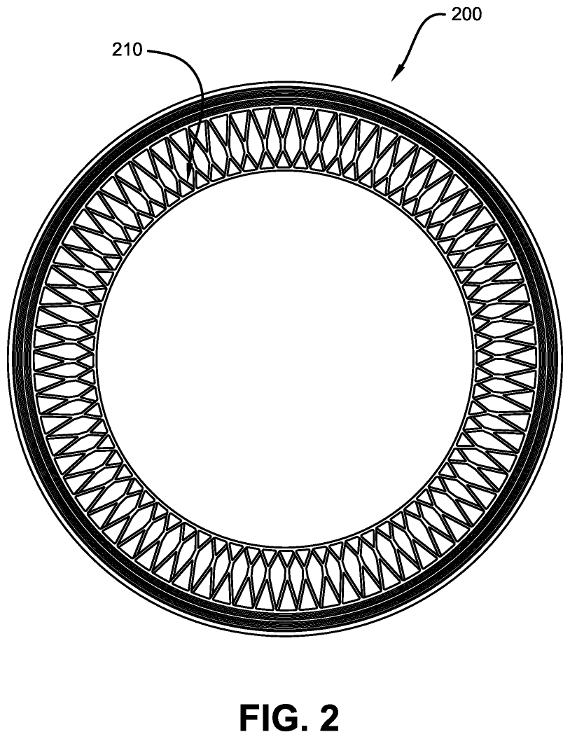

As shown in FIG. 2, an example non-pneumatic tire 200 functionally similar to the tire of FIG. 1 may have one or more spoke disks 210 axially, radially, and rotationally aligned with each other. The spoke disks 210 may bend or deform axially outward, while the spoke disks may also bend in an angular plane. The spoke disks 210 may be laterally stiff so that they can be combined to tune the tire axial stiffness.

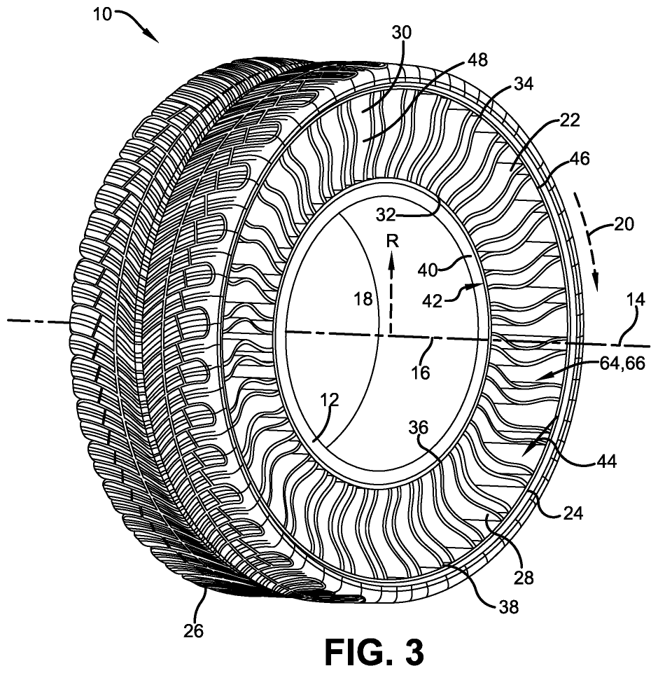

As shown in FIG. 3, another example non-pneumatic tire 10 functionally similar to the tire of FIG. 1 may have a static discharge element 30 for use in conducting electricity through the tire 10 to prevent or reduce the chances of shocking a person touching the vehicle and to remove unwanted static electricity from the vehicle. The static discharge element 30 may be located at the supporting structure 22 of the non-pneumatic tire 10 in order to transfer the electricity across the supporting structure 22. The supporting structure 22 may be constructed of materials that have poor electrically conductive properties. The static discharge element 30 may be electrically conductive and may be made in a variety of manners. In some examples, the static discharge element 30 may be elastic so that it may deflect with supporting structures 22 that are likewise elastic.

The non-pneumatic tire 10 may have an axis of rotation about the central axis 14. The central axis 14 may extend in an axial direction 16 of the tire 10. The central axis 14 may extend through an opening of a hub 12 of the tire 10. The radial direction of the tire 10 may be oriented at a perpendicular angle to the central axis 14, such that the hub 12 is spaced radially inwards from other portions of the tire 10, such as the supporting structure 22 and the tread 16. The non-pneumatic tire 10 may also have a circumferential direction 20 about which various portions of the tire 10 extend. For example, the tread 26, shear band 24, supporting structure 22, and hub 12 may all extend 360 degrees in the circumferential direction 20 about the central axis 14.

The supporting structure 22 may engage the hub 12 and be located outward from the hub 12 in the radial direction 18. The supporting structure 22 may include a series of spokes 28 extending from the hub 12 to the shear band 24 in the radial direction 18. It is to be understood that the supporting structure 22 need not include spokes 28. For example, the supporting structure 22 may be made of a series of elements arranged into a honeycomb like structure that extends 360 degrees about the central axis 14. In another example, the supporting structure 22 may be a solid member that extends 360 degrees about the central axis 14 in the circumferential direction 20.

The supporting structure 22 may have a first radial end 32 at the hub 12 that coincides with a first radial terminal end 36 of the spoke 28. The spoke 28 may extend in the radial direction 18 to the shear band 24, in which a second radial end 34 of the supporting structure 22 may be located. As the spoke 28 terminates at/in the shear band 24, the second radial terminal end 38 of the spoke 28 may similarly be located at the second radial end 34. The shear band 24 may be located outward from the various spokes 28 in the radial direction 18 and may extend 360 degrees about the central axis 14 in the circumferential direction 20. The tread 26 of the example non-pneumatic tire 10 may be outward from the shear band 24 in the radial direction 18 and may extend completely around the central axis 14 in the circumferential direction 20.

The spoke 28 may flex during rotation of the tire 10 and the spoke 28 may have an elongation of 10 percent, 0-4 percent, 4-5 percent, 5-15 percent, 8-12 percent, 9-11 percent, 10-13 percent, 10-15 percent, 15-25 percent, up to 30 percent, or up to 50 percent. The spoke 28 may be made of polyurethane and thus may not have adequate electrical conductivity.

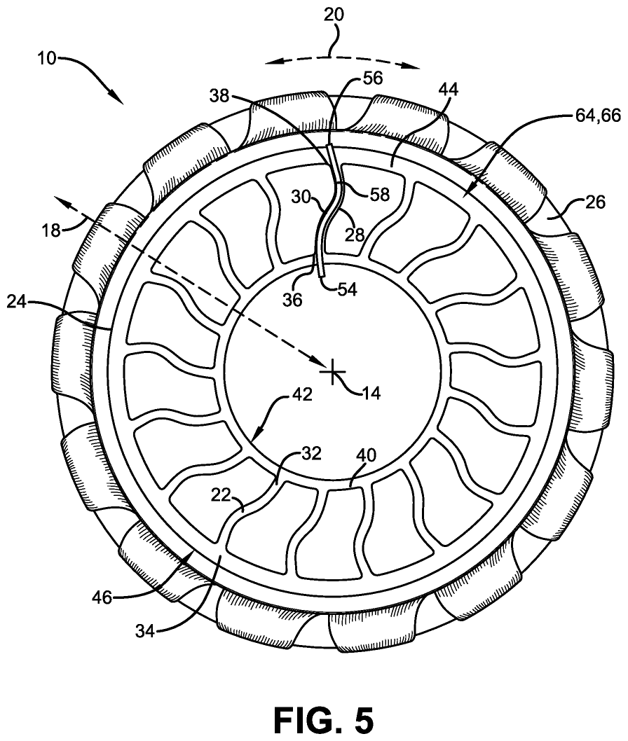

As shown in FIG. 5, an alternative arrangement of an example non-pneumatic tire 10 may include a static discharge element 30 including a filament fiber filler 68 injected into the other material of the supporting structure 22. The supporting structure 22 may have an inner interface ring 40, an outer interface ring 44, and a plurality of spokes 28. These components 28, 40, 44 may be constructed of polyurethane with a filler made up of the filament fibers 68. The filament fibers 68 may be mixed into the polyurethane and distributed about the components 28, 40, 44. In other examples, the components 28, 40 and 44 and any other portions of the supporting structure 22 may be made of reinforced and/or non-reinforced material, such as a polymeric material. The polymeric material may be polyurethane, co-polyester, polyether block amide, and/or polyolefins. Still further, other examples of the non-pneumatic tire 10 as described herein may include components, such as the spoke 28, the inner interface ring 40, the outer interface ring 44, and the supporting structure 22, with different types of polymeric materials.

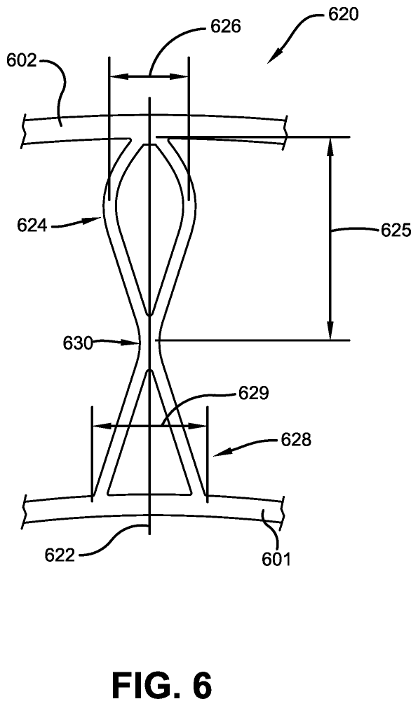

As shown in FIGS. 1 and 6, in accordance with the present invention, a tire 600 may have a radially inner first rim 601, a radially outer second rim 602, and a top loaded connecting structure 610 interconnecting the first rim 601 and the second rim 602. Such a connecting structure 610 may be more flexible/compliant than the above described conventional tires. The connecting structure 610 may include a plurality of load bearing elements, or spokes 620. The connecting structure 610 may include between 4 and 80, between 20 and 60, between 30 and 50, about 40, and/or about 36 (FIG. 1) elements 620, depending on load requirements, dimensions, materials, spoke configurations, etc.

Each element 620 may be symmetric about a radially extending midplane 622 and have a radially outward-facing fish-like structure. Each element 620 may include a radially outer teardrop loop 624 and a radially inner triangular structure 628 having two angled legs. A radially inner vertex of the teardrop loop 624 and a radially outer vertex of the triangular structure 628 may converge/meet at a single location 630. This connecting structure 610 may show improved fatigue life compared to the conventional designs. The elements 620 may be scalable to any tire/rim and provide lower hysteresis/heat build-up and little, if any, snapping effect on failure. More importantly, this connecting structure 610 may provide ride/handling performance and load-bearing capability comparable to current high performance passenger tires.

The elements 620 may be uniform (FIG. 1) or varied (not shown) with axial widths that may be the full width of the tire 600. The maximum radial height 625 of the tear drop loop 624 may be less than or equal to the maximum circumferential width 626 of the teardrop loop 624. The ratio of the maximum radial height 625 to the maximum circumferential width 626 may be in the range between 1.00 and 2.00, 1.00 and 1.50, 0.99 and 1.50, 1.10 and 1.40, 1.20 and 1.30, and/or about 1.25. The circumferential width 629 of the triangular structure 628 may be greater than (FIG. 6), less than, or equal to the circumferential width 626 of the teardrop loop 624.

While the present invention has been described in connection with certain preferred examples, it is to be understood that the subject matter encompassed by way of the present invention is not to be limited to those specific examples. On the contrary, it is intended for the subject matter of the present invention to include all alternatives, modifications, and/or equivalents as may be included within the spirit and scope of the following claims.

What is claimed:

1. A tire comprising
a radially inner annular rim with a central axis;
an annular shearband disposed radially outward from the inner rim;
an annular supporting structure disposed radially outward from the inner rim, the supporting structure radially interconnecting the inner rim and the shearband;
an annular tread disposed radially outward from the shearband, and
the supporting structure including a plurality of spokes each having a radially outer teardrop loop and a radially inner triangular structure with a radially inner vertex of the teardrop loop and a radially outer vertex of the triangular structure converging at a single location, a ratio of a maximum radial height of the teardrop loop to a maximum circumferential width of the teardrop loop being in a range between 1.00 and 2.00.

2. The tire as set forth in claim 1 wherein the supporting structure includes between 4 and 80 spokes.

3. The tire as set forth in claim 1 wherein the supporting structure includes between 20 and 60 spokes.

4. The tire as set forth in claim 1 wherein the supporting structure includes between 30 and 50 spokes.

5. The tire as set forth in claim 1 wherein the supporting structure includes 40 spokes.

6. The tire as set forth in claim 1 wherein the supporting structure includes 36 spokes.

7. The tire as set forth in claim 1 wherein each spoke is symmetric about a radially extending midplane of each spoke.

8. The tire as set forth in claim 1 wherein each spoke has a radially outward-facing fish-like structure.

9. The tire as set forth in claim 1 wherein each triangular structure has two angled legs.

10. The tire as set forth in claim 1 wherein each spoke has a uniform construction.

11. The tire as set forth in claim 1 wherein a first spoke has a first construction and a second spoke has a second, different construction.

12. The tire as set forth in claim 1 wherein each spoke has a uniform axial width.

13. The tire as set forth in claim 1 wherein the ratio is in a range between 1.00 and 2.00.

14. The tire as set forth in claim 1 wherein the ratio is in a range between 1.10 and 1.40.

15. The tire as set forth in claim 1 wherein the ratio is in a range between 1.20 and 1.30.

16. The tire as set forth in claim 1 wherein a maximum circumferential width of each triangular structure is greater than the maximum circumferential width of the teardrop loop.

17. A method for supporting part of a vehicle load, the method comprising the steps of:
extending a radially inner annular rim circumferentially about a central axis;
extending an annular shearband circumferentially about the central axis;
radially interconnecting the inner rim and the shearband with an annular supporting structure;
extending an annular tread circumferentially radially outward from the shearband;
converging a radially inner vertex of a teardrop loop of the support structure and a radially outer vertex of a triangular structure of the support structure at a single location; and
defining a ratio of a maximum radial height of a teardrop loop of the supporting structure to a maximum circumferential width of the teardrop loop in a range between 1.00 and 2.00.

18. The method as set forth in claim 17 further including the step of defining a ratio of a maximum radial height of a teardrop loop of the supporting structure to a maximum circumferential width of the teardrop loop in a range between 1.00 and 1.50.

19. The method as set forth in claim 17 further including the steps of defining a first construction of a first spoke of the supporting structure and defining a second different construction of a second spoke of the support.

20. The method as set forth in claim 17 further including the step of defining the supporting structure spokes having radially outward-facing fish-like structures symmetric about a radial midplane.
